(19) United States
(12) Patent Application Publication
(10) Pub. No.: US 2007/0280107 A1
(43) Pub. Date: Dec. 6, 2007

(54) Data Unit Sender Control Method

(76) Inventors: Reiner Ludwig, Hurtgenwald (DE); Michael Meyer, Aachen (DE); Hannes Ekstrom, Stockholm (SE)

Correspondence Address: ERICSSON INC., 6300 LEGACY DRIVE, M/S EVR 1-C-11, PLANO, TX, 75024, US

(21) Appl. No.: 11/572,534

(22) PCT Filed: Jul. 23, 2004
(86) PCT No.: PCT/EP04/08287

§ 371 Date: Aug. 14, 2007

(51) Int. Cl. H04L 12/24; H04L 1/00; H04L 1/16

(52) U.S. Cl. 370/230

(57) ABSTRACT

A method of controlling a data unit sender is described. A flow control procedure for controlling the flow of data units sent by said data unit sender is conducted in dependence on acknowledgement messages from the receiver The flow control procedure utilizes (S103) at least one output limiting parameter (olp; cwnd) for placing a limit on the data units sender's current data send rate. A procedure is provided for detecting (S110) a data unit loss indication, in response to the detection of a data unit loss indication, performing (S311) a retransmission, subsequent to said retransmission (S311) waiting (S312) for an acceptable acknowledgment message carrying the sequence position identifier indicative of said data unit indicated as potentially having been lost, and distinguishing (S317) whether said acceptable acknowledgment message relates to an original transmission, and in response to distinguishing that said acceptable acknowledgment message does not relate to said original transmission, performing (S318) a congestion response step, while in response to distinguishing that said acceptable acknowledgment message relates to said original transmission, said output limiting parameter is adapted (S319) based on one or more duplicate acknowledgment messages received since receiving the last acceptable acknowledgment message that precedes the acceptable acknowledgment message carrying the sequence position identifier indicative of said data unit indicated as potentially having been lost.

### FIELD OF THE INVENTION

The present invention relates to a method of controlling a data unit sender, to a corresponding data unit sender, to a communication system comprising first and second data unit senders and a data unit receiver, and to a method of controlling such a system.

### BACKGROUND OF THE INVENTION

Data unit oriented communication is well-known. In data unit oriented communication, an amount of data is divided into one or more data units, where the structure of the data units is defined by a communication protocol to which the sender and receiver in the communication adhere. The protocol also defines how specific information is to be coded, and how the sender and/or receiver may react to specific information. Data unit oriented communication is also known as packet exchange communication. It should be noted that such units or sub-divisions of data are referred to by different names in connection with specific protocols, such as packets, frames, segments, protocol data units, service data units, etc. For the purpose of the present description and claims, the term “data unit” is used generically to refer to all types of units used in data unit oriented communication.

A feature that many communication protocols use for increasing reliability is that of letting the receiver send acknowledgement messages to the sender, which acknowledgment messages provide information on the receipt of the data units. More specifically, a sender or sending peer of the given protocol sends out data units, and the receiver or receiving peer returns acknowledgement messages that give information on the receipt or non-receipt of the data units. For example, positive acknowledgement messages or ACKs may be sent, which acknowledge the correct receipt of one or more data units, and/or non-acknowledgement messages (NACKs), which specifically indicate data units that were not correctly received. The expression “not correctly received” means received with an incorrectable error or not received at all. Based on this information, the sending peer can accordingly adjust the flow control of the further data units to be sent.

The sending peer sends the data units in a sequence, and each data unit carries a sequence position identifier, e.g. a byte or bit count value of an overall data stream being transported in the data units. The receiving peer uses the sequence position identifiers in the acknowledgment messages. It is furthermore known to use so-called cumulative acknowledgment messages, which carry the sequence position identifier indicative of the last data unit that was correctly received in the order of the sequence. In other words, the receiving peer does not only monitor whether a data unit is correctly received, but also whether it is in the proper order of the sequence with respect to the data units that were previously received correctly. If a data unit is correctly received, but out of order of the sequence (e.g. data units no. 1 to 5 have been received and then data unit no. 7 arrives), then the receiving peer continues to acknowledge the last data unit correctly received in the order of the sequence (no. 5 in the example just given). This can lead to so-called duplicate acknowledgments, i.e. acknowledgment messages that carry a sequence position identifier that was already carried in a previous acknowledgment message. The sending peer can use these duplicate acknowledgments as information that the receiving peer received a data unit out of order of the sequence. An example of a protocol that uses cumulative acknowledgement messages is the so-called Transmission Control Protocol (TCP).

In order to regulate the flow of data units, it is known to use one or more output limiting parameters that place a limit on the sending peer's momentary data send rate. In window-based flow control, the congestion window (as e.g. known from TCP) is such an output limiting parameter. The congestion window expresses the maximum amount of data that the sending peer may have outstanding at one time. “Outstanding” means that a data unit was sent but not yet acknowledged as correctly received. Therefore, the congestion window also limits the amount of data that the sending peer can send at one time.

The sending peer also has a procedure for adapting the output limiting parameter in response to acceptable acknowledgment messages, where an acceptable acknowledgment messages is one that is associated with a data unit that was not previously acknowledged. For example, the congestion window can be increased in response to each acceptable acknowledgment message. In TCP, the increase procedure uses the so-called slow-start and congestion avoidance algorithms.

Due to the fact that a certain amount of time passes between sending a data unit and receiving an associated acknowledgment, the so-called round-trip-time (RTT), the result of the congestion window is a limit on how much data can be sent per RTT, which amounts to a rate limitation.

Another example of an output limiting parameter is the send limit rate in a rate-based flow control scheme.

It is noted that there can be more than one output limiting parameter, e.g. the so-called advertised window known from TCP.

In order to cope with the fact that data units sent from the sender to the receiver may get lost, it is known to implement procedures for detecting a data unit loss indication. A data unit loss indication can e.g. be detected by counting the number of duplicate acknowledgment messages, comparing the counted number with a predetermined threshold value, where the data loss indication is given if the counted number reaches or exceeds the threshold value. Another example of a procedure for detecting a data unit loss indication is monitoring a time-out period after sending a given data unit, and considering it a data unit loss indication if the time-out period expires without having received an acknowledgment messages reporting the correct receipt of the given data unit. This timeout period may be referred to as a Retransmission Time-Out period, abbreviated as RTO, e.g. as done in TCP, and the timer started after transmitting a data unit may be abbreviated as REXMT.

Staying with the example of TCP, it is known to react to the detection of a data unit loss indication by re-transmitting the data unit that the data unit loss indication indicates as potentially having been lost, and to adjust flow control parameters in such a way so as to reduce a potential congestion in the network transporting the data units from the sender to the receiver. In other words, the data unit loss indication is taken as indicating an actual data loss, and the data unit loss is interpreted as a sign of congestion in the network. The congestion alleviation done by TCP consist in among other things reducing the congestion window, which may be abbreviated as cwnd.

It is known that data unit loss indications are not always caused by actual data unit losses. For example, the expiring of a re-transmission timer or the repeated sending of feedback messages that indicate a missing data unit can also be caused by the delaying of a data unit in the network. Such delaying can lead to the phenomenon of re-ordering, in which a later sent data unit arrives at the receiver before an earlier sent one, such that the receiver detects the earlier sent data unit as missing. Such delaying can also lead to so-called delay spikes, in which an entire group of data units is delayed, however, without any reordering taking place. In view of this situation, proposals for improving the sender flow control have been made.

EP-1 018 821 proposes a system in which after a data loss indication is detected, the sender re-transmits the potentially lost data unit and reduces the congestion window, as done in conventional TCP. However, thereafter the sender analyses the acknowledgement messages or ACKs received from the receiver, and distinguishes whether the next acceptable acknowledgement message is associated with the original transmission or the re-transmission. If this next acceptable ACK is associated with the re-transmitted data unit, then the previous data unit loss indication is considered as confirmed. On the other hand, if the ACK is associated with the original transmission, then it is clear that a data unit loss has not occurred. As a response to such a recognition, EP-1 018 821 suggests returning the congestion window to the value it had before reacting to the data unit loss indication, as that reaction can then be judged as having been wrong.

In the publication “TCP-DCR: A Novel Protocol for Tolerating Wireless Channel Errors” by S. Bhandarkar et al. and a corresponding internet-draft for the Internet Engineering Task Force (IETF), it has been proposed to modify TCP in such a way that in response to a third duplicate acknowledgment message or DUPACK, the sender does not immediately react, but much rather waits for a predetermined period of time until either an acceptable acknowledgement for the missing data unit is received or the predetermined time passes. If the acceptable acknowledgement is received, then this shows that the three DUPACKS were not caused by a data unit loss, and if the time period expires, then the system reacts like a normal TCP sender, i.e. re-transmits the missing data unit and reduces the congestion window in accordance with congestion control principles. This concept is referred to as delayed congestion response (DCR) and the passing of the predetermined time period is monitored by setting the so-called DCR timer upon receiving a third DUPACK and observing whether the DCR timer expires before receiving an acceptable acknowledgement.

WO 2004/047357 describes a method of controlling a data unit sender that uses a longer and a shorter time-out period, where a retransmission of a designated data unit is performed after the shorter time-out period if an available transmission capacity for unsent data at that time is greater or equal to the size of the designated data unit. One embodiment of this document provides for the option of delayed congestion control, according to which the designated data unit is retransmitted and it is then waited until an acceptable acknowledgment message for the designated data unit is received. It is also disclosed to distinguish whether the acknowledgment message relates to the original transmission or the retransmission.

### OBJECT OF THE INVENTION

It is the object of the invention to provide an improved method of flow control in a data unit sender and a correspondingly improved data unit sender.

### SUMMARY OF THE INVENTION

This object is solved by the subject-matter described in the independent claims. Advantageous embodiments are described in the dependent claims.

According to one aspect of the invention, there is provided a system and a method of controlling a communication that comprises a first data unit sender, a second data unit sender and a data unit receiver. The first data unit sender is arranged to operate as a sending peer of a first communication protocol according to which
a sending peer sends data units in a sequence, each data unit carrying a sequence position identifier,
a receiving peer acknowledges the correct receipt of data units with acknowledgement messages, where each acknowledgement message carries a sequence position identifier indicative of the last data unit that was correctly received in the order of said sequence. For example, the sequence position identifier can be that of the last data unit correctly received in-order, or in a predetermined relationship to the sequence position identifier of the last data unit received in-order, e.g. the sequence position identifier of the immediately preceding data unit. The communication protocol belongs to a first layer, e.g. the transport layer L4.

The second data unit sender is arranged to operate as a sending peer of a second communication protocol that belongs to a second layer lower than said first layer, e.g. the link layer L2, said further data unit sender being arranged to receive in the order of said sequence data units of a third communication protocol that belongs to a third layer over said second layer, e.g. the network layer L3. The data unit receiver is arranged to operate as a receiving peer of said second communication protocol.

A controlling of said first data unit sender comprises
a flow control procedure for controlling the flow of data units sent by said data unit sender in dependence on said acknowledgement messages, and said flow control procedure utilizing an output limiting parameter for placing a limit on the data unit sender's current data send rate,
a procedure for
detecting a data unit loss indication,
in response to the detection of a data unit loss indication, performing a retransmission of a data unit that said data unit loss indication indicates as potentially having been lost, but not performing a congestion response step for adapting said output limiting parameter for alleviating congestion,
subsequent to said retransmission waiting for an acceptable acknowledgment message carrying the sequence position identifier indicative of said data unit indicated as potentially having been lost, and
distinguishing whether the acceptable acknowledgment message relates to an original transmission of said data unit indicated as potentially having been lost, and
in response to distinguishing that said acceptable acknowledgment message does not relate to said original transmission, performing said congestion response step.

A controlling of said second data unit sender comprises embedding said data units of said third communication protocol in data units of said second communication protocol, and sending said data units of said second communication protocol to said data unit receiver, a controlling of the data unit receiver comprises reconstructing said data units of said third communication protocol from said data units of said second communication protocol, and releasing data units of said third communication protocol upwards, where releasing said data units out of order of said sequence is allowed.

In other words, on the receiving side, out-of-order delivery is allowed.

In contrast to conventional TCP or e.g. EP-1 018 821, the congestion response step in the upper layer (first) data unit sender is not conducted in direct response to the data unit loss indication, because it is first waited whether the acceptable acknowledgment in fact corroborates the data unit loss or not. Namely, if the acceptable acknowledgement message received after the retransmission does not relate to the original transmission, then this corroborates the data unit loss (it does not confirm or prove the data unit loss, because the data unit in question might still be strongly delayed). On the other hand, if the acceptable acknowledgement message received after the retransmission relates to the original transmission, then this means that despite the data unit loss indication, no data unit loss has in fact occurred. As a consequence, a congestion response step for adapting the flow control to a situation where data unit losses are occurring, is only conducted if the data unit loss is corroborated.

An important feature in this aspect of the invention therefore consists in the separation of the data unit re-transmission procedure and the congestion response procedure. Namely, while the data unit re-transmission procedure is linked to the procedure for detecting a data unit loss indication, the congestion response procedure is linked to a data unit loss corroboration procedure. This is in complete contrast to both the concepts described in EP-1 018 821 as well as the DCR proposal, because in both of these prior art concepts the congestion alleviation and the re-transmission are conducted together. In EP-1 018 821 the re-transmission and congestion alleviation are performed concurrently in response to the data unit loss indication, and a correction of the congestion alleviation is potentially performed later, and in DCR the entire operation of re-transmission and congestion alleviation is postponed until the DCR timer has expired, in which case the retransmission and congestion alleviation are again performed concurrently.

An important advantage of the concept of the present invention is that the performance of the first data unit sender becomes independent of events such as sudden delay spikes or packet reordering. Namely, a data unit loss indication (such as a time-out or a predetermined number of duplicate acknowledgments) caused by reordering or a delay spike can be identified as not being due to an actual loss, and the conventional congestion response step, which reduces the sender's output by reducing the send rate, can be avoided. As a consequence, reordering and delay spikes do not lead to an unnecessary reduction in sending performance. This in turn means that the conventional requirement of in-order-delivery from the second layer upward on the receiving side can be dropped. Therefore, the implementation of the second layer components can be greatly simplified. The requirement of in-order-delivery requires considerable resources, such as re-sequencing buffers. In the present invention, these re-sequencing buffers are not necessary. Also, the entire second layer design is simpler.

According to another aspect of the invention, there is provided a method of controlling a data unit sender and such a data unit sender, arranged to operate in accordance with a communication protocol according to which a sending peer sends data units in a sequence, each data unit carrying a sequence position identifier, a receiving peer acknowledges the correct receipt of data units with acknowledgement messages, where each acknowledgement message carries a sequence position identifier indicative of the last data unit that was correctly received in the order of said sequence. For example, the sequence position identifier can be that of the last data unit correctly received in-order, or in a predetermined relationship to the sequence position identifier of the last data unit received in-order, e.g. the sequence position identifier of the immediately preceding data unit. The control comprises a flow control procedure for controlling the flow of data units sent by said data unit sender in dependence on said acknowledgement messages, said flow control procedure being arranged to recognize duplicate acknowledgement messages that carry a sequence position identifier that was already carried in a previously received acknowledgment message, and said flow control procedure utilizing an output limiting parameter (i.e. one or more) for placing a limit on the data units sender's current data send rate. A procedure is provided for adapting said output limiting parameter for increasing said limit in dependence on acceptable acknowledgment messages, an acceptable acknowledgment message being an acknowledgment message that is associated with a data unit that was not previously acknowledged. A procedure is provided for
detecting a data unit loss indication,
in response to the detection of a data unit loss indication, performing a retransmission of a data unit that said data unit loss indication indicates as potentially having been lost, but not performing a congestion response step for alleviating congestion by adapting said output limiting parameter,
subsequent to said retransmission waiting for an acceptable acknowledgment message carrying the sequence position identifier indicative of said data unit indicated as potentially having been lost, and
distinguishing whether said acceptable acknowledgment message relates an said original transmission of said data unit indicated as potentially having been lost.

In response to distinguishing that the acceptable acknowledgment message does not relate to said original transmission, which corroborates the data unit loss, the congestion response step is performed. In response to distinguishing that the acceptable acknowledgment message relates to the original transmission, which means that the data unit loss indication does not relate to a data unit loss, the output limiting parameter is adapted based on one or more duplicate acknowledgment messages received since receiving the last acceptable acknowledgment message that precedes the acceptable acknowledgment message carrying the sequence position identifier indicative of said data unit indicated as potentially having been lost.

Duplicate acknowledgment messages indicate the correct receipt of data units, albeit out of order. If it is later determined that the data unit loss indication does not relate to an actual data unit loss, then one may conclude that reordering has occurred. This means that if the reordering had not occurred, then the duplicate acknowledgments would have been acceptable acknowledgments, which in turn would have been used by the sender to adapt the output limiting parameter, e.g. increase the congestion window in a window-based scheme. The present aspect of the invention therefore teaches to use information on the duplicate acknowledgments with respect to adapting the output limiting parameter(s) if it is distinguished that no data unit loss has occurred. The output limiting parameter is thereby better adapted to the situation, which leads to better and more efficient flow control.

The two above described aspects of the invention have in common the advantageous use of reordering itself or the effects of reordering. Namely, in the first aspect, out-of-order delivery is allowed at a lower layer receiver, thereby making the lower layer simpler. At the same time, the upper layer sender's flow control is made robust against the reordering that out-of-order delivery at the lower layer is likely to cause. In the second aspect, the sender's flow control is arranged to make positive use of information generated due to reordering or delay spikes, with respect to adapting the output limiting parameter(s)

### BRIEF DESCRIPTION OF FIGURES

The present invention will now be described by referring to specific embodiments, which in turn refer to the figures, in which:

FIG. 1 shows a flowchart of a flow control method of the present invention;

FIGS. 2a-2d show flow charts of procedures for responding to the receipt of a duplicate acknowledgment;

FIG. 3 shows a flow chart of a procedure for reacting to a data unit loss indication;

FIG. 4 shows a schematic block diagram of a data unit sender arranged according to the present invention;

FIG. 5 shows an overview of sending and receiving peers of three protocol layers; and

FIG. 6 gives an overview of an embodiment of the present invention.

### DETAILED DESCRIPTION OF EMBODIMENTS

In the following, the description will make reference to specific protocol layers, such as the link layer and the network layer, and to specific protocols, such as TCP, but it should be noted that the present invention is by no means restricted to such specific layers or specific protocols, as it can be applied in the context of any data unit sender that acts as a sending peer of a protocol that uses cumulative acknowledgments.

Nonetheless, the concept of the present invention can preferably be applied to TCP or a TCP-like protocol. A TCP-like protocol is a communication protocol that is like TCP at least in the following characteristics: the flow control is window-based, the sender is arranged to send data units in a sequence, each data unit carrying a sequence position identifier, and the data unit receiver is arranged to acknowledge the correct receipt of data units with acknowledgment messages that carry the sequence position identifier indicative of the last data unit that was correctly received in the order of said sequence, i.e. in-sequence, the sender maintains a congestion control window like the parameter cwnd known from TCP, the sender has a timeout feature (like RTO and REXMT known from TCP) and a feature for counting duplicate feedback messages (i.e. that repeatedly indicate the same data unit as missing, such as the DUPACKS known from TCP) for detecting a data unit loss indication, and a congestion response or alleviation procedure is provided, in which at least the congestion window is reduced. Preferably, the congestion response procedure also comprises setting the slow-start threshold to one half the send window, and then either performing slow-start (if the data loss was initially indicated by a time-out) or performing congestion avoidance (if the data unit loss was initially indicated by the reaching of a threshold value of DUPACKs).

It is noted that although the present specification uses some terms known in connection with TCP (such as RTO, REXMT, congestion window cwnd, slow-start threshold ssthresh, acceptable ACK, DUPACK, advertised window, send window, slow-start, congestion avoidance, fast recovery, etc.), these terms are all to be understood as generically relating to any TCP-like protocol, i.e. a protocol that operates like TCP with respect to the mentioned parameters, but may be otherwise different from TCP.

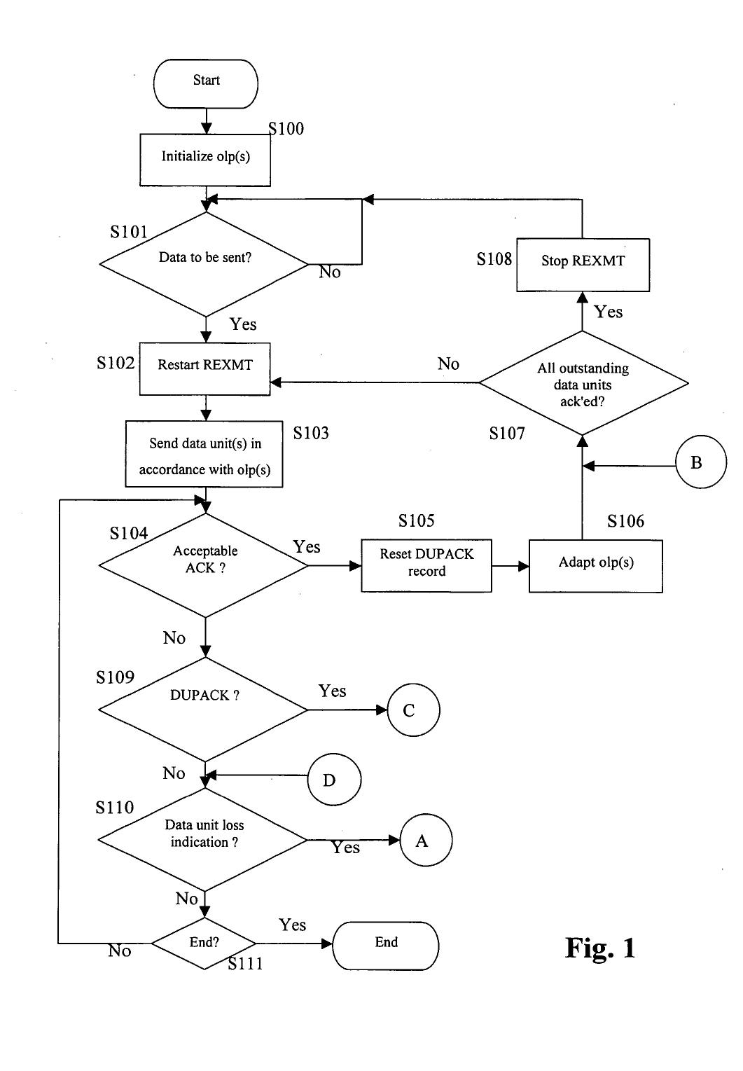

FIG. 1 shows a flowchart of a basic method of flow control in a data unit sender in accordance with the present invention. The data unit sender is arranged to operate in accordance with a communication protocol according to which a sending peer sends data units in a sequence, each data unit carrying a sequence position identifier, a receiving peer acknowledges the correct receipt of data units with acknowledgement messages, where each acknowledgement message carries the sequence position identifier indicative of the last data unit that was correctly received in the order of said sequence. The communication protocol can e.g. be a transport protocol arranged on the transport layer, such as TCP. The sequence position identifiers can be chosen in any suitable or desirable way, e.g. can be consecutive numbers (e.g. 1,2, 3 . . . ) or a bit or byte count of a data stream being transported, as known from TCP.

In a first step S100, one or more output limiting parameters olp for placing a limit on the data unit sender's data send rate are initialised. As already mentioned, examples of olps are a congestion window in a window based system or a data send rate in a rate based system.

The congestion window expresses the maximum amount of data that the sending peer may have outstanding at one time. “Outstanding” means that a data unit was sent but not yet acknowledged as correctly received. In a protocol using a congestion window cwnd, cwnd can e.g. be initialised to a value that corresponds to a predetermined data unit size, e.g. one Maximum Segment Size (MSS). It is noted that the congestion window can be expressed in terms of an amount of data (e.g. in bytes) or in terms of a number of data units.

The method then proceeds to step S101, in which it is determined whether there is any data to send. If e.g. the present invention is applied at the transport layer, step S101 determines whether the higher layer (e.g. the application layer) is providing data for transport. The procedure waits until data is available. If data is available, then step S102 starts the retransmission timer REXMT. REXMT is set to a predetermined time-out value RTO. Then the procedure advances to step S103, in which one or more data units are sent in accordance with the one or more olps being used.

After step S103, step S104 determines whether an acceptable acknowledgment has been received. An acceptable acknowledgment is an acknowledgment message that is associated with a data unit that was not previously acknowledged. Generally this means that an acceptable acknowledgment carries a sequence position identifier that was not carried in a previous acknowledgment. However, it is to be noted that a so-called wrap-around can occur with respect to the sequence position identifiers, i.e. in the course of a session the limited number of sequence position identifiers (e.g. due to being coded by a limited number of bits) can jump back to an initial value. The data unit sender therefore determines an acceptable ACK by determining whether a received ACK carries a sequence position identifier that has not occurred since the last wrap-around.

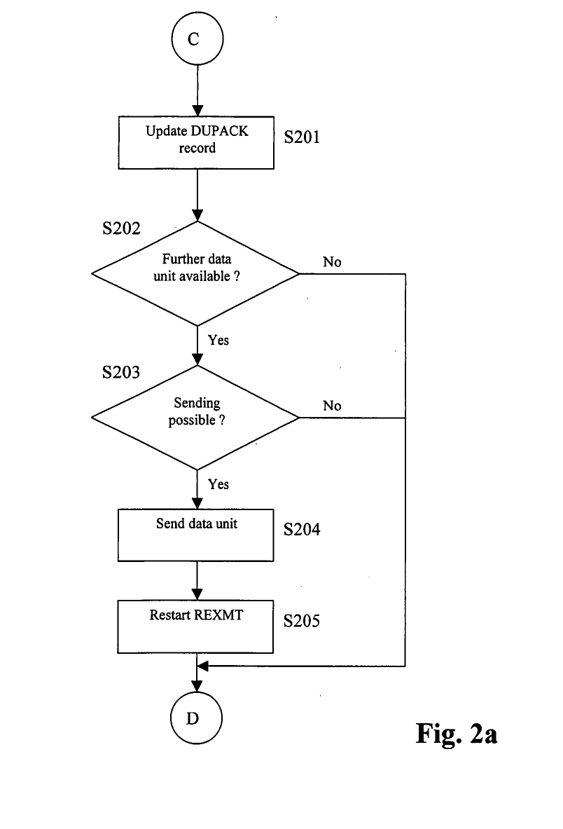

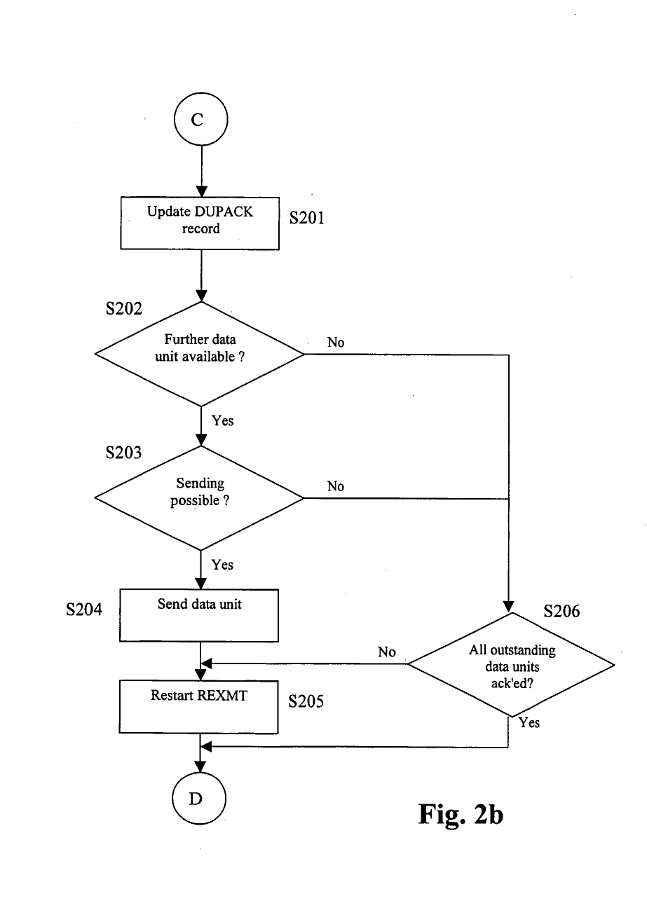

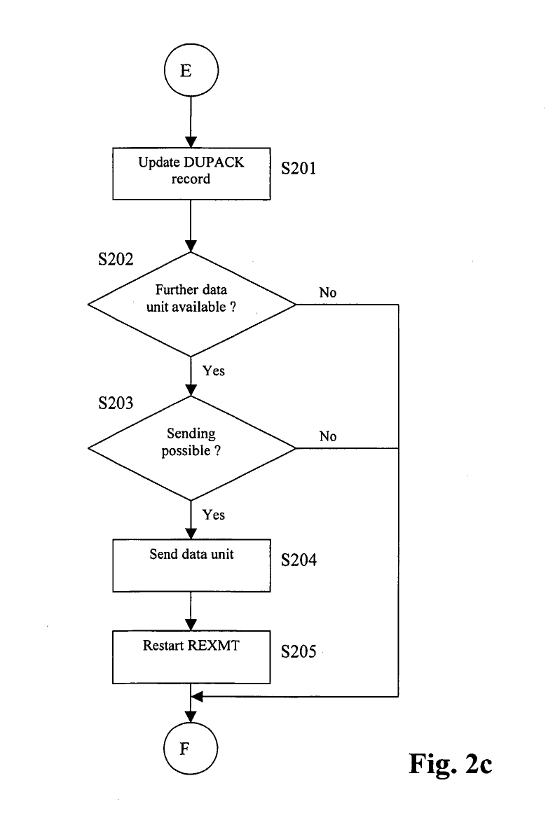

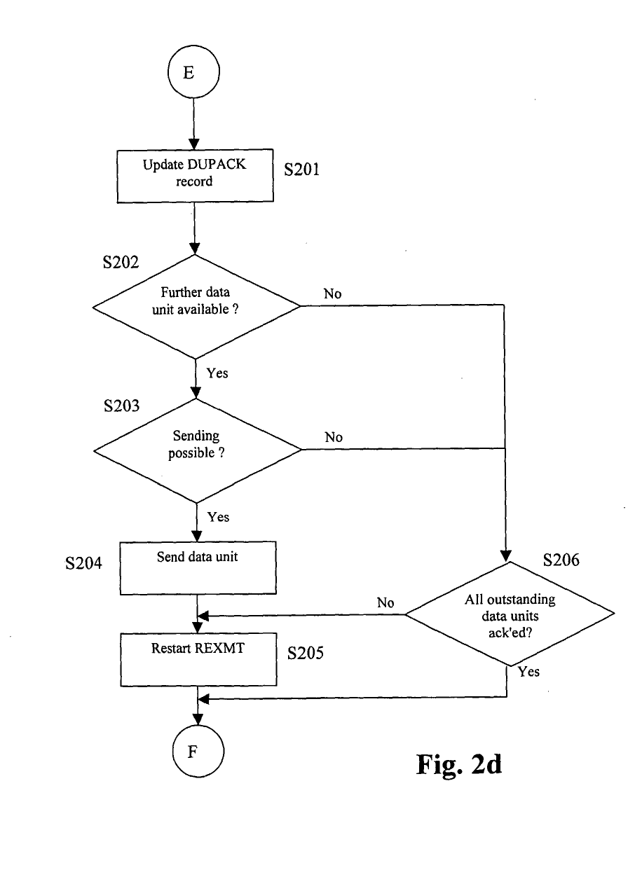

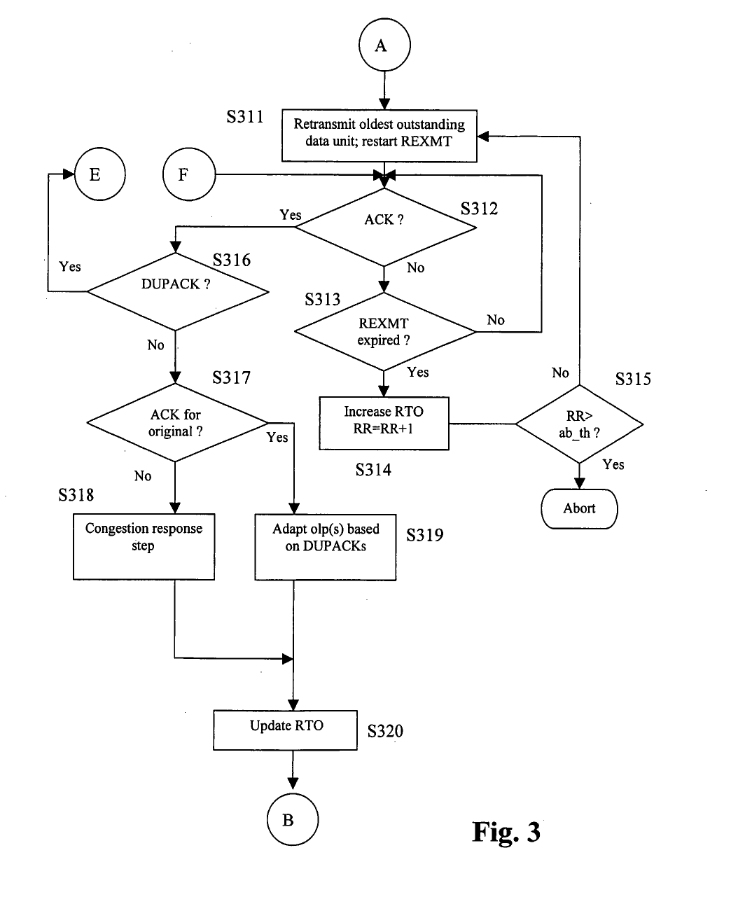

If step S104 determines that an acceptable ACK was received, the procedure advances to step S105, in which a DUPACK record is reset. The significance of step S105 will be described later in connection with the procedures of FIGS. 2 and 3. Then step S106 adapts the one or more olps in such a way so as to increase the limit. For example, if the olp is cwnd, then cwnd is increased. This increase can be chosen in any suitable or desirable way, e.g. as known from TCP. That is, if cwnd is smaller than the slowstart threshold ssthresh, then cwnd is increased by adding MSS to cwnd, and if cwnd exceeds ssthresh, then cwnd is increased by adding MSS²/cwnd to cwnd. The procedure then passes to step S107, in which it is determined whether all outstanding data units have been acknowledged, or more specifically whether there are any outstanding data units left. “Outstanding” means that a data unit was sent, but no acknowledgement for its receipt has yet been received. If all outstanding data units have been acknowledged, REXMT is stopped in step S108 and the sending peer then goes back to S101 to wait for further data. If not, the procedure passes to step S102.

If the outcome of step S104 is no, then the procedure passes to step S109, in which it is recognised whether a duplicate acknowledgment (DUPACK) was received or not. A DUPACK is an ACK that is associated with a data unit that has already been acknowledged previously, i.e. that carries a sequence position identifier that was already carried in a previous ACK since the last wrap-around. If a DUPACK was received, then the procedure passes to point C as shown in FIG. 2a or 2b, which outline procedures for responding to a DUPACK.

In step S201 of FIG. 2a, the DUPACK record is updated. Similar to step S105, the significance of step S201 will be described later in connection with preferred embodiments of step S319 of FIG. 3. In step S202 it is determined whether a further data unit is available for sending (e.g. in a buffer of as of yet unsent data or coming from a higher layer), and if yes, step S203 determines whether there are restraints to sending the further data unit. Such restraints can e.g. be due to any of the olps. In a window-based protocol, it is checked whether cwnd allows the sending of a further data unit. Step S203 can also involve checking other olps, such as e.g. an advertised window as known from TCP. If the outcome of step S203 is also yes, then the further data unit is sent and REXMT is restarted in S205. If any one of steps S202 and S203 provide a negative outcome (answer “no”), then steps S204 and S205 are skipped. The procedure of FIG. 2a is an example of the concept of responding to the receipt of a duplicate acknowledgment message by sending a further data unit, if the output limiting parameters allow and said further data unit is available for sending. This corresponds to the idea of data unit conservation, i.e. the receipt of a DUPACK is an indication that one data unit has successfully left the network connecting the sending and the receiving peer, such that there should be room for a new data unit.

FIG. 2a is an example of the concept of restarting the monitoring whether a time-out period has passed, every time that a further data unit is sent in response to receiving a duplicate acknowledgement message.

An alternative to the procedure of FIG. 2a is shown in FIG. 2b. Steps S201-S205 are the same as in FIG. 2a, such that a repeated description is not necessary. The difference between the procedures of FIGS. 2a and 2b is step S206 in FIG. 2b, which follows a negative outcome (answer “no”) from steps S202 or S203. Step S206 is the same as step S107 of FIG. 1, i.e. determines whether all outstanding data units have been acknowledged. If this is the case, then the procedure advances to point D, i.e. exists. On the other hand, if there are outstanding data units, then step S205 is performed, i.e. REXMT is restarted. FIG. 2b is an example of the concept of restarting the monitoring whether a time-out period has passed, every time that a duplicate acknowledgement message is received and there are data units outstanding.

The procedure then returns to the steps of FIG. 1 at step S110. In step S110 it is determined whether a data unit loss indication is present. The data unit loss indication can be chosen in any suitable or desirable way. For example step S110 can comprise determining whether REXMT has expired, which is an example of monitoring a predetermined time-out period (RTO) after sending a given data unit, and judging a data unit loss indication to be present if said predetermined time-out period passes without having received an acceptable acknowledgment message carrying the sequence position identifier associated with said given data unit. Another example is counting a number of duplicate acknowledgement messages, comparing said counted number with a threshold value and judging a data unit loss indication to be present if said counted number reaches or exceeds said threshold value. This DUPACK threshold may be a fixed value (such as 3) or an adaptive parameter.

If S110 does not determine a data unit loss indication to be present, an abort condition is checked in step S111 (e.g. an external command from an application to end communication), and if the procedure continues, it loops back to step S104, to continue waiting for an acceptable ACK, a DUPACK or a data unit loss indication. In other words, the steps S104, S109, S110 are checked continuously over time.

On the other hand, if the outcome of S110 indicates the presence of a data unit loss indication, then a corresponding response procedure is enabled, which comprises:

performing a retransmission of a data unit that said data unit loss indication indicates as potentially having been lost, but not performing a congestion response step for alleviating congestion by adapting said output limiting parameter,

subsequent to said retransmission waiting for an acceptable acknowledgment message carrying the sequence position identifier indicative of said data unit indicated as potentially having been lost, and
distinguishing whether said acceptable acknowledgment message relates to an original transmission of said data unit indicated as potentially having been lost, and in response to distinguishing that said acceptable acknowledgment message does not relate to said original transmission, performing said congestion response step, while in response to distinguishing that said acceptable acknowledgment message relates to said original transmission, adapting said output limiting parameter based on one or more duplicate acknowledgment messages received since receiving the last acceptable acknowledgment message that precedes the acceptable acknowledgment message carrying the sequence position identifier indicative of said data unit indicated as potentially having been lost.

An example of this will be explained in connection with FIG. 3. The procedure of FIG. 3 starts with step S311, which performs the retransmission of the oldest outstanding data unit, and at the same time the timer REXMT for monitoring the time-out period RTO is restarted. “Outstanding” means that the data unit was sent, but no acknowledgement for its receipt has yet been received. The term “oldest” refers to the lowest sequence position identifier among the sequence of the outstanding data units.

It is noted that the retransmission of the oldest outstanding data unit in step S311 is identical to the reaction of a standard TCP sender, but it should also be noted that in contrast to a standard TCP sender, the sender of the present invention does not perform any congestion control reaction in step S311. Much rather, the sender waits until it can corroborate whether the detected data unit loss indication of S110 was an actual data unit loss or not.

For this purpose the procedure enters loop S312, S313, S314 and S315. In step S312, it is asked whether an acknowledgment for the retransmitted data unit has been received. If not, It is asked in step S313 whether the retransmission timer REXMT has expired. If not, then the procedure loops back to step S312. If the retransmission timer has expired, the procedure passes to step S314, in which the value of RTO is appropriately increased (e.g. doubled), and a count value RR, which stands for restart retransmission, is increased by 1. Thereafter, step S315 is executed, in which it is determined whether the value of RR exceeds an abortion threshold ab_th. This abortion threshold can e.g. have a value of 10, such that if ten loops occur without receiving an acknowledgment, the procedure is aborted and it is assumed that the connection between the sender and receiver is interrupted. On the other hand, if RR does not exceed the threshold, the procedure loops back to step S311 for retransmitting the oldest outstanding data unit and restarting the retransmission timer REXMT.

If the outcome of step S312 indicates that an ACK has been received, then step S316 determines whether it is an acceptable ACK or a DUPACK. If it is a DUPACK, then a DUPACK response procedure as described in connection with FIG. 2c or 2d is performed and the procedure thereafter goes back to step S312. The procedure of FIG. 2c is identical to that of FIG. 2a, and the procedure of FIG. 2d is identical to that of FIG. 2b, such that a repeated description is not necessary.

If step S316 determines that it is not a DUPACK, the process proceeds to S317, in which it is determined whether the ACK is for the original transmission or the retransmission. If the ACK is for the retransmission (outcome “no” of S317) the procedure goes to step S318, in which a standard congestion response step is performed. For example, in a window-based system this may comprise reducing the congestion window. In a rate-based system this may comprise reducing the send rate. The reduction of the congestion control window or send rate can be performed in the same way as this is done in conventional systems in which the retransmission and congestion response are performed in a single linked step.

On the other hand, if the ACK is for the original (outcome “yes” of step S317), the procedure passes to step S319, in which the one or more output limiting parameters olp are adapted based on one or more DUPACKS received between the two last acceptable ACKs.

The procedure for determining whether an acknowledgment message reports the receipt of the data unit retransmitted at S311 or a previous transmission can be done in any suitable or desirable way. For example, the principles outlined in EP-1 018 821 A1 can be employed, namely that the sender adds a specific marking to sent data units, where said marking allows a distinction between original transmissions and retransmissions. The receiver then mirrors these markings in the acknowledgment messages. Such markings can be a single bit (one setting for original transmission and the other setting for retransmission), a bit string that contains more information, or a time-stamp that reflects the time of sending the respective data unit.

Regarding step S317, it is noted that the “original transmission” may itself be a retransmission, such that the “retransmission” can be the retransmission of a retransmission, etc. In other words, the data unit loss indication that triggers the data unit retransmission procedure may be related to a data unit that itself was retransmitted previously in response to an earlier data unit loss indication.

Finally, the processing passes to step S320, in which RTO may be appropriately updated. The procedure then returns to the process of FIG. 1 at step S107.

The adapting based on the DUPACKs can be done in any suitable or desirable way. Preferably, this is done by a duplicate acknowledgment record keeping procedure that comprises adapting a duplicate acknowledgment record parameter based on received duplicate acknowledgment messages, where in response to distinguishing that the acceptable acknowledgment message carrying the sequence position identifier indicative of the data unit indicated as potentially having been lost relates to an original transmission, the output limiting parameter is adapted on the basis of said duplicate acknowledgment record parameter. The duplicate record keeping parameter can be chosen in any suitable or desirable way, e.g. can be a counter for counting a number of duplicate acknowledgment messages. It can be an upward counter (1,2,3 . . . ) or a downward counter. The counting result can be used in any suitable or desirable way to adapt the output limiting parameter. For example, in a window-based protocol, the congestion window can be increased by a value that depends linearly on the number of DUPACKs received between the last two acceptable ACKs.

The duplicate acknowledgment record parameter can also be a dummy output limiting parameter.

The record keeping procedure preferably operates by appropriately reacting to the receipt of a DUPACK or acceptable ACK. Namely, in response to a DUPACK, the duplicate acknowledgment record parameter is appropriately updated (see step S201 in FIG. 2), and in response to an acceptable ACK, the DUPACK record parameter is reset (see S105 in FIG. 1). The specific way of updating and resetting can be chosen in any suitable or desirable way, and will generally depend on the chosen DUPACK record parameter. For example, if it is a counter, the resetting means resetting to a predetermined initial value (e.g. 0), and the updating means adding or subtracting a predetermined difference value (e.g. 1).

When using a dummy output limiting parameter, e.g. a dummy version of the congestion window in a window based protocol, then the resetting may comprise setting said dummy output limiting parameter on the basis of a momentary value of said output limiting parameter upon each receipt of an acceptable acknowledgment message. For example, the dummy congestion window (referred to as cwnd_aix in the following) can be set equal to the momentary value of cwnd, or equal to the sum of cwnd and a predetermined value. The adapting or updating of the dummy output limiting parameter in response to duplicate acknowledgment messages (S201) is preferably done in the same way as the procedure for adapting the output limiting parameter adapts the output limiting parameter in response to acceptable acknowledgment messages.

For example, in a window-based protocol this can be accomplished in the following way. The dummy value cwnd_aix, which at this point in time is not used in the flow control procedure, is increased in response to each received DUPACK. The degree of increase of the dummy congestion window cwnd_aix can be performed as it is known from TCP for acceptable acknowledgments, namely during the slow start phase (if cwnd_aix<ssthresh), the dummy congestion window cwnd_aix is increased by the equivalent of a maximum data unit size (e.g. Maximum Segment Size MSS) for each DUPACK, and in the congestion avoidance phase (if cwnd_aix>ssthresh), the dummy congestion window cwnd_aix is increased by the square of the maximum data unit size divided by the dummy congestion window size. As both the slow start and congestion avoidance algorithms are well known in the art, a further description is not necessary here.

Then, depending on the outcome of the data unit loss corroboration procedure, the dummy value cwnd_aix can be used to adapt the actual congestion window cwnd. More specifically, if the data unit loss corroboration procedure does not corroborate the data unit loss (“yes” in step S317 of FIG. 3), then the adaptation procedure S319 will adapt cwnd on the basis of cwnd_aix. For example, cwnd can be set to the value of cwnd_aix. Preferably, a mechanism is implemented in accordance with which cwnd approaches cwnd_aix less abruptly. This can e.g. be done by setting the slow-start threshold ssthresh to the value of cwnd_aix, such that (because cwnd_aix>cwnd) the flow control will enter slow-start and exponentially grow the congestion window cwnd up to the value of cwnd_aix.

This is an example of the general concept that in response to distinguishing that the acceptable acknowledgment message carrying the sequence position identifier indicative of said data unit indicated as potentially having been lost relates to an original transmission, said output limiting parameter is set to the value of said dummy output limiting parameter. Preferably, in response to distinguishing that the acceptable acknowledgment message carrying the sequence position identifier indicative of the data unit indicated as potentially having been lost relates to an original transmission, a procedure is conducted for letting the output limiting parameter gradually approach the value of said dummy output limiting parameter.

According to a preferred embodiment of the invention, the data unit sender is arranged to set a time-stamp indicative of the time of sending in each sent data unit. The data unit receiver will be arranged to set the time-stamp of the last correctly received data unit in any acceptable or duplicate acknowledgment being sent, and the data unit sender is in turn arranged to perform roundtrip time (RTT) measurements based on the time stamps received both in the acceptable and the duplicate acknowledgments. For example, the sender can subtract the value of the time stamp in the received ACK or DUPACK from its momentary system time, in order to directly derive an RTT estimate. This concept is a departure from conventional TCP-like systems, as conventional TCP prescribes that the data unit receiver echos the time-stamp of the last data unit correctly received in-sequence into any acknowledgments, such that the duplicate acknowledgments would not contain the time-stamp of the data unit that was received last. The advantage of this present preferred embodiment is that the data unit sender can perform more precise RTT measurements from DUPACKs, which increases the precision of the RTT estimation.

According to a further preferred embodiment, a procedure is provided for adapting the output limiting parameter in such a way as to reduce the data units sender's current data send rate in response to distinguishing that said acceptable acknowledgment message carrying the sequence position identifier indicative of said data unit indicated as potentially having been lost relates to an original transmission. The adapting is done in dependence on an amount of idle time that passed between the last sending of a data unit and the receipt of said acceptable acknowledgment message carrying the sequence position identifier indicative of the data unit indicated as potentially having been lost. A corresponding step can e.g. be arranged immediately subsequent to S319 of FIG. 3.

In response to such a corroboration of non-loss, a procedure for changing the sender output limiting parameter in such a way as to reduce the sender output is performed, where the amount of change depends on an amount of idle time that passes between the last sending of a data unit and the confirming that the potentially lost data unit was not lost. For example, in a TCP-like sender, if the idle time is shorter than RTO, no change is performed, and if the idle time is longer than RTO, the sender output limiting parameter is changed in dependence on the ratio of the idle time and RTO.

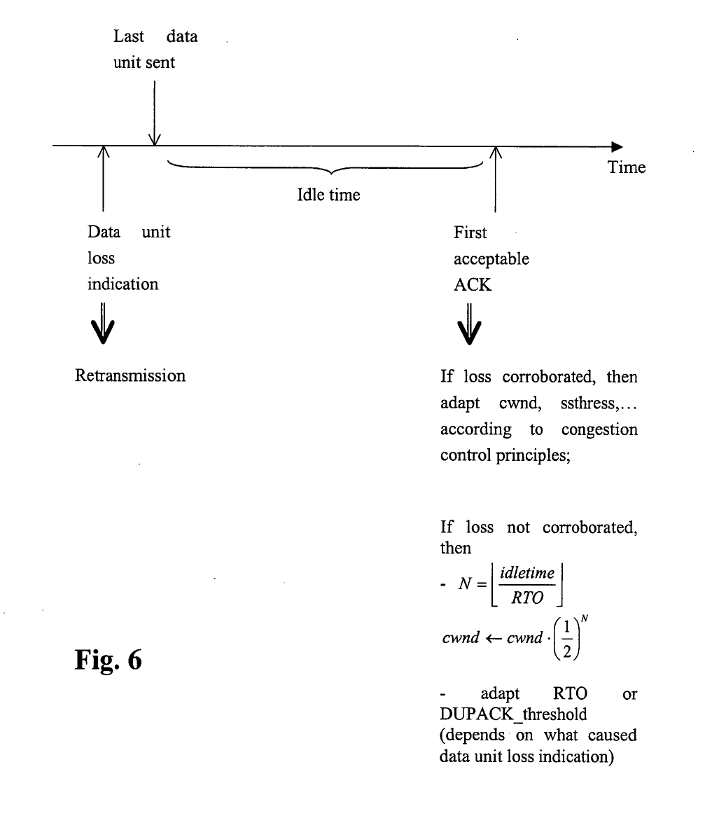

This will be explained by referring to the diagram shown in FIG. 6. FIG. 6 shows a time arrow, and as a first event, a data unit loss indication is shown. This data unit loss indication.leads to a retransmission at that point in time, as described above in connection with step S311 of FIG. 3. After the retransmission is triggered by the data unit loss indication, it is possible that one or more further data units are sent, depending on the specific control options and the situation. It is, however, also possible that the retransmission in connection with the data unit loss indication is in fact the last data unit sent, before an idle time occurs, which is due to the data unit sender waiting for the first acceptable ACK related to the data unit retransmitted in response to the data unit loss indication. When the first acceptable ACK arrives, then it is distinguished whether the loss is corroborated or not (step S317 of FIG. 3). If the loss is corroborated, namely if the ACK relates to the retransmission performed in response to the data unit loss indication, then the standard congestion control parameter adaptation is performed, e.g. reducing the congestion window cwnd to the size of one data unit, replacing the slow-start threshold by one half its value, etc.

On the other hand, if the loss is not corroborated, i.e. the acceptable ACK relates to the original transmission and not the retransmission, then step S319 is performed for adapting the olp based on the DUPACKS received between the two last acceptable ACKs. Afterwards, it is in principle possible to simply return to the regular flow control procedure (see point B in FIG. 1 and 3).

However, it is preferable to have the above-mentioned procedure for reducing the sender output limiting parameter (e.g. the congestion window cwnd) in dependence on the idle time, because the situation on which the estimation of this value of this sender output limiting parameter is based might have changed during the idle time, such that it is preferable to take a conservative approach and reduce the limiting parameter.

It is noted that step S319 adapts the olp based on DUPACKs. If several DUPACKs have arrived between the two last acceptable ACKs, then each DUPACK will usually have led to the sending of a further data unit (see step S204 of FIG. 2), such that the idle time will be short. As will be explained in more detail further on, a short idle time preferably leads to no further action with respect to the olp. However, if no or very few DUPACKs have arrived, then the idle time may be significant, and the value of the olp (e.g. the congestion window) will not have been updated based on recent acceptable ACKs (step S106) or recent DUPACKs (step S319). As such the value of olp may have become “stale”, such that it is preferable to let it decay in dependence on the amount of idle time.

The reduction in dependence on the idle time can be done in any suitable or desirable way, e.g. in a simple proportional relationship with respect to a given fixed time factor. For example, one could replace cwnd by cwnd/F, where F=idle time/Δ and Δ is a predetermined constant.

If the data unit sender can detect a data unit loss indication by monitoring a time-out period, as this is the case for TCP-like operation, then the reducing of the sender output limiting parameter is preferably done in dependence on a comparison between the idle time and the time-out period. For example, in such a case the above-mentioned constant Δ could be replaced by the adaptable value of RTO. According to the present embodiment of FIG. 6, the adaptation of the congestion window is done in such a way that N is determined as the truncated fraction of idle time divided by RTO, and then the congestion window is halved N times.

As a further preferable response to the non-corroboration, the embodiment of FIG. 6 teaches to adapt the value of RTO or the DUPACK threshold appropriately. For example, if the data unit loss indication was a time-out, then non-corroboration preferably leads to an increasing of the time-out period RTO, as this non-corroboration indicates that the RTO was too short. For example, RTO can be doubled.

Equally, if the data unit loss indication was caused by the reaching of the DUPACK threshold, then the DUPACK threshold can be raised in response to the non-corroboration, as this threshold was apparently too low. Preferably, the adaptation of the DUPACK threshold value occurs by monitoring the outcome of the data unit loss corroboration procedure over time. More specifically, the outcome of distinguishing step S317 is monitored for different data unit loss indication detection events. For example, the data unit sender can keep statistics on the number of non-corroborations subsequent to data unit loss indications due to the reaching or exceeding of the DUPACK threshold, and then increase or decrease the DUPACK threshold depending on the frequency of non-corroboration (i.e. the number of non-corroborations over a predetermined period time). If the frequency exceeds a predetermined upper limit, then the DUPACK threshold can be raised by a predetermined factor (e.g. 1 is added), and if the frequency is below a predetermined lower limit, then the DUPACK threshold can be reduced by a predetermined factor (e.g. 1 is subtracted).

The DUPACK threshold can also be adapted on the basis of the number of DUPACKs received between acceptable ACKs, or more specifically the number of duplicate acknowledgment messages received since receiving the last acceptable acknowledgment message that precedes the acceptable acknowledgment message carrying the sequence position identifier indicative of the data unit indicated as potentially having been lost. Namely, this number reflects the re-ordering length, and it is desirable to set the DUPACK threshold in accordance with the re-ordering length. For example, if a predetermined first re-ordering length threshold is exceeded, then the DUPACK threshold can be increased by a predetermined amount (e.g. 1), and if the re-ordering length falls below a predetermined second re-ordering length threshold, then the DUPACK threshold can be decreased by a predetermined amount (e.g. 1).

The present invention has up to now been described in the context of methods for performing flow control in a data unit sender. As such, the present invention can also be embodied as a computer program product comprising a computer program that is arranged to execute one or more of the above methods when executed in a data unit sender.

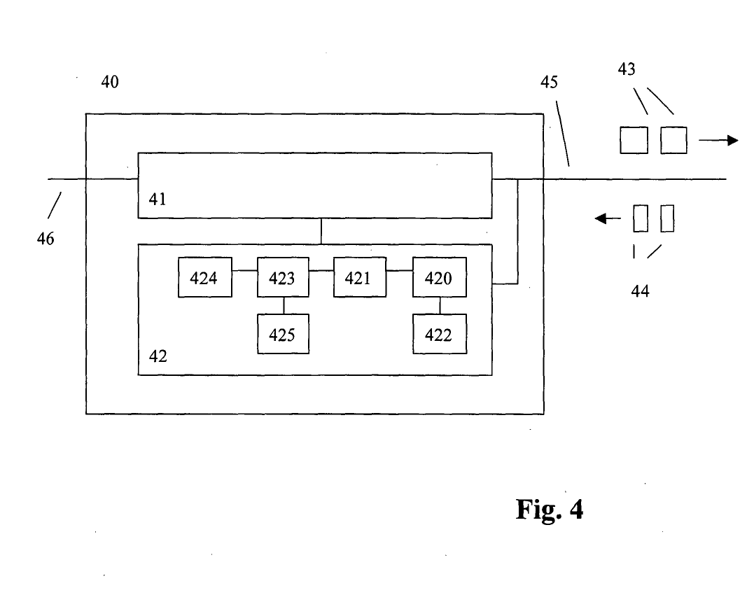

The present invention can furthermore be embodied in a data unit sender, as shall be explained in connection with the schematic block diagram of FIG. 4. FIG. 4 shows a data unit sender 40 arranged to operate in accordance with a communication protocol according to which a sending peer sends data units 43 in a sequence, each data unit carrying a sequence position identifier, a receiving peer (not shown) acknowledges the correct receipt of data units with acknowledgement messages 44, where each acknowledgement message 44 carries the sequence position identifier indicative of the last data unit that was correctly received in the order of said sequence. A flow controller 42 is provided for controlling the flow of data units 43 sent by the data unit sender 40 in dependence on the acknowledgement messages 44, and for utilizing at least one output limiting parameter for placing a limit on the data unit sender's current data send rate. FIG. 4 schematically shows a buffer device 41, which is arranged to hold data coming from higher layers via connection 46, to hold data units for sending and to hold received ACKs. As such the buffer device 41 may consist of a plurality of individual buffers (e.g. an input buffer and an output buffer). The flow controller 42 is arranged to recognize duplicate acknowledgement messages among the ACKs 44.

An adaptor 425 is provided for adapting the output limiting parameter for increasing said limit in dependence on acceptable acknowledgment messages. A detector 420 is provided for detecting a data unit loss indication. A retransmitter 422 is provided for performing a retransmission of a data unit that said data unit loss indication indicates as potentially having been lost, in response to the detection of a data unit loss indication. A monitor 421 is provided for waiting for an acceptable acknowledgment message carrying the sequence position identifier indicative of said data unit indicated as potentially having been lost, subsequent to said retransmission. A distinguisher 423 is provided for distinguishing whether said acceptable acknowledgment message relates to an original transmission of said data unit indicated as potentially having been lost.

A congestion responder 424 is provided for performing a congestion response step for adapting said output limiting parameter for alleviating congestion, the congestion responder being triggered in response to the distinguisher 423 distinguishing that the acceptable acknowledgment message does not relate to the original transmission, but not being triggered by the detector 420 detecting a data unit loss indication. The adaptor 425 is furthermore arranged for adapting the output limiting parameter based on one or more duplicate acknowledgment messages received since receiving the last acceptable acknowledgment message that precedes the acceptable acknowledgment message carrying the sequence position identifier indicative of said data unit indicated as potentially having been lost, in response to the distinguisher 423 distinguishing that the acceptable acknowledgment message does not relate to the retransmission.

The above mentioned controller 42 and the elements 420-425 can be provided as hardware, software or any suitable combination of hardware and software. Preferably, the detector 420, monitor 421, data unit retransmitter 422, distinguisher 423, congestion responder 424 and adaptor 425 are provided as program code parts in a computer program executed by a programmable controller 42.

As already mentioned previously, the present invention has the advantage that the sender's performance becomes independent of events such as sudden delay spikes or packet reordering. Due to the fact that the likelihood of such disturbances occurring is increased in wire-less communications, the present invention is preferably applied to wire-less data unit senders, e.g. to mobile telephones.

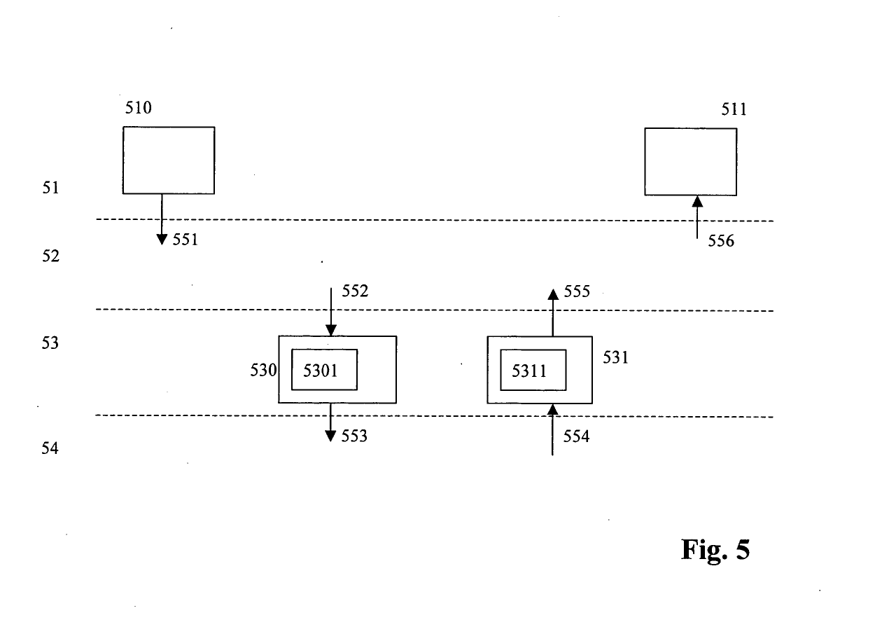

Now a further aspect of the present invention will be described with reference to FIG. 5. A communication system is shown that comprises a data unit sender 510 arranged to operate as a sending peer of a first communication protocol at a first layer 51. The corresponding receiving peer 511 of layer 51 is also shown. Layer 51 can e.g. be the transport layer L4, and the communication protocol can e.g. be TCP. The sending peer sends data units 551 in a sequence, each data unit carrying a sequence position identifier, the receiving peer acknowledges the correct receipt of data units with acknowledgement messages, where each acknowledgement message carries the sequence position identifier indicative of the last data unit that was correctly received in the order of said sequence. The data unit sender 510 is arranged very similar to the data unit sender of FIG. 4. It comprises a flow controller for controlling the flow of data units 551 sent by the data unit sender in dependence on said acknowledgement messages, and for utilizing at least one output limiting parameter for placing a limit on the data unit sender's current data send rate. A detector is provided for detecting a data unit loss indication. A retransmitter is provided for performing a retransmission of a data unit that said data unit loss indication indicates as potentially having been lost, in response to the detection of a data unit loss indication. A monitor is provided for waiting for an acceptable acknowledgment message carrying the sequence position identifier indicative of said data unit indicated as potentially having been lost, subsequent to said retransmission. A distinguisher is provided for distinguishing whether the acceptable acknowledgment message relates to an original transmission of said data unit indicated as potentially having been lost. A congestion responder is provided for performing a congestion response step for adapting said output limiting parameter for alleviating congestion, the congestion responder being triggered in response to said distinguisher distinguishing that said acceptable acknowledgment message does not relate to said original transmission, but not being triggered by the detector detecting a data unit loss indication.

The detector, monitor, data unit retransmitter, distinguisher, congestion responder and adaptor may be provided as program code parts in a computer program executed by a programmable processor acting as the flow controller.

The system of FIG. 5 furthermore comprises a second data unit sender 530 arranged to operate as a sending peer of a second communication protocol that belongs to a second layer 53 lower than said first layer 51. For example, layer 53 can be the link layer L2. The second data unit sender 530 is arranged to receive in the order of said sequence data units 552 of a third communication protocol that belongs to a third layer 52 over said second layer 53. The third layer 52 can be identical to the first layer 51. On the other hand, if layer 51 is the transport layer L4, and layer 53 is the link layer L2, then layer 52 can be the network layer L3.

The second sender 530 comprises an embedding controller for embedding the data units 552 of the third communication protocol in data units of the second communication protocol. “Embedding” means to encapsulate or segment the data units 552 of layer 52 into data units 553 of layer 53. A send controller is provided for sending the data units 553 of said second communication protocol to a corresponding receiving peer of said second communication protocol. The embedding controller and send controller can both be embodied in the form of a programmable processor 5301.

FIG. 5 also shows a data unit receiver 531 arranged to operate as the receiving peer of said second communication protocol at layer 53. Receiver 531 comprises a reconstruction controller for controlling the reconstruction of data units 555 of said third communication protocol (in effect reversing the operation of embedding performed at second sender 530), and a release controller for releasing data units 555 of said third communication protocol upwards. In accordance with the present invention, the release controller is arranged to be allowed to release the data units 555 of the third communication protocol out of order of said sequence. The reconstruction controller and release controller can both be embodied in the form of a programmable processor 5311.

After possible processing at layer 52 (not shown), the data units 556 of layer 51 are passed upwards to layer 51 receiving peer 511. Receiving peer 511 then sends corresponding acknowledgment messages (not shown), as described in detail with respect to the embodiments of FIGS. 1-4 and 6.

The senders 510 and 530 may be provided in one physical location, i.e. in one device, e.g. a mobile phone or a base station of a mobile communication system. On the other hand, they can also be physically separated. Equally, the receivers 531 and 511 may be provided in one physical location, i.e. in one device, e.g. a mobile phone or a base station of a mobile communication system, or they can also be physically separated. In general, the lower layer peers 530 and 531 can be provided anywhere along the path over which data units of layer 51 are being sent from sender 510 to receiver 511.

In the system of FIG. 5, the conventional requirement of in-order-delivery from the lower layer 53 upward on the receiving side has been dropped. Therefore, the implementation of the second layer receiving peer 531 can be greatly simplified. The requirement of in-order-delivery requires considerable resources, such as re-sequencing buffers. In the present invention, these re-sequencing buffers are not necessary. Thereby, the entire second layer design is simpler.

Although the present invention has been described by making reference to specific detailed embodiments, these are only provided for the purpose of better explaining the invention, but the scope of the invention is defined by the appended claims. Equally, reference signs in the claims are not intended to be limiting, but only serve to make the claims easier to read.

1. A method of controlling a data unit sender arranged to operate in accordance with a communication protocol according to which a sending peer sends data units in a sequence, each data unit carrying a sequence position identifier, a receiving peer acknowledges the correct receipt of data units with acknowledgement messages, where each acknowledgement message carries a sequence position identifier indicative of the last data unit that was correctly received in the order of said sequence, said method comprising:
a flow control procedure for controlling the flow of data units sent by said data unit sender in dependence on said acknowledgement messages, said flow control procedure being arranged to recognize duplicate acknowledgement messages that carry a sequence position identifier that was already carried in a previously received acknowledgment message, and said flow control procedure utilizing an output limiting parameter for placing a limit on the data units sender's current data send rate,
a procedure for adapting said output limiting parameter for increasing said limit in dependence on acceptable acknowledgment messages, an acceptable acknowledgment message being an acknowledgment message that is associated with a data unit that was not previously acknowledged,
a procedure for
detecting a data unit loss indication,
in response to the detection of a data unit loss indication, performing a retransmission of a data unit that said data unit loss indication indicates as potentially having been lost, but not performing a congestion response step for alleviating congestion by adapting said output limiting parameter,
subsequent to said retransmission waiting for an acceptable acknowledgment message carrying the sequence position identifier indicative of said data unit indicated as potentially having been lost, and
distinguishing whether said acceptable acknowledgment message relates to an original transmission of said data unit indicated as potentially having been lost, and
in response to distinguishing that said acceptable acknowledgment message does not relate to said original transmission, performing said congestion response step,
in response to distinguishing that said acceptable acknowledgment message relates to said original transmission, adapting said output limiting parameter based on one or more duplicate acknowledgment messages received since receiving the last acceptable acknowledgment message that precedes the acceptable acknowledgment message carrying the sequence position identifier indicative of said data unit indicated as potentially having been lost.

2. The method of claim 1, further comprising a duplicate acknowledgment record keeping procedure that comprises adapting a duplicate acknowledgment record parameter based on received duplicate acknowledgment messages, where in response to distinguishing that said acceptable acknowledgment message carrying the sequence position identifier indicative of said data unit indicated as potentially having been lost relates to said original transmission, said output limiting parameter is adapted on the basis of said duplicate acknowledgment record parameter.

3. The method of claim 2, wherein said duplicate acknowledgment record parameter is a counter for counting a number of duplicate acknowledgment messages.

4. The method of claim 2, wherein said duplicate acknowledgment record parameter is a dummy output limiting parameter.

5. The method of claim 4, wherein said record keeping procedure comprises adapting said dummy output limiting parameter in response to duplicate acknowledgment messages in the same way as said procedure for adapting said output limiting parameter adapts said output limiting parameter in response to acceptable acknowledgment messages.

6. The method of claim 4, wherein said record keeping procedure comprises setting said dummy output limiting parameter on the basis of a momentary value of said output limiting parameter upon each receipt of an acceptable acknowledgment message.

7. The method of claim 4, wherein in response to distinguishing that said acceptable acknowledgment message carrying the sequence position identifier indicative of said data unit indicated as potentially having been lost relates to said original transmission, said output limiting parameter is set to the value of said dummy output limiting parameter.

8. The method of claim 4, wherein in response to distinguishing that said acceptable acknowledgment message carrying the sequence position identifier indicative of said data unit indicated as potentially having been lost relates to said original transmission, a procedure is conducted for letting said output limiting parameter gradually approach the value of said dummy output limiting parameter.

9. The method of claim 1, wherein said flow control in said data unit sender is window-based and said sender output limiting parameter is a congestion control window.

10. The method of claim 1, wherein said flow control in said data unit sender is rate-based and said sender output limiting parameter is a send rate parameter.

11. The method of claim 1, further comprising a procedure for adapting said output limiting parameter in such a way as to reduce the data unit sender's current data send rate in response to distinguishing that said acceptable acknowledgment message carrying the sequence position identifier indicative of said data unit indicated as potentially having been lost relates to said original transmission, said adapting being done in dependence on an amount of idle time that passed between the last sending of a data unit and the receipt of said acceptable acknowledgment message carrying the sequence position identifier indicative of said data unit indicated as potentially having been lost.

12. The method of claim 11, wherein said procedure for detecting a data unit loss indication comprises monitoring a predetermined time-out period after sending a given data unit, and judging a data unit loss indication to be present if said predetermined time-out period passes without having received an acceptable acknowledgment message carrying the sequence position identifier indicative of said given data unit, and wherein said idle time dependent adapting of said sender output limiting parameter comprises comparing said amount of idle time to said time-out period.

13. The method of claim 1, wherein said flow control in said data unit sender is dependent on said output limiting parameter and further output limiting parameters, and comprises responding to the receipt of a duplicate acknowledgment message by sending a further data unit, if said output limiting parameter and said further output limiting parameters allow and said further data unit is available for sending.

14. The method of claim 13, wherein said procedure for detecting a data unit loss indication comprises monitoring a predetermined time-out period after sending a given data unit, and judging a data unit loss indication to be present if said predetermined time-out period passes without having received an acceptable acknowledgment message carrying the sequence position identifier indicative of said given data unit, wherein the monitoring whether the time-out period has passed is restarted every time that a further data unit is sent in response to receiving a duplicate acknowledgement message.

15. The method of claim 1, wherein said procedure for detecting a data unit loss indication comprises monitoring a predetermined time-out period after sending a given data unit, and judging a data unit loss indication to be present if said predetermined time-out period passes without having received an acceptable acknowledgment message carrying the sequence position identifier indicative of said given data unit, wherein the monitoring whether the time-out period has passed is restarted every time that a duplicate acknowledgement message is received and there are data units outstanding.

16. The method of claim 1, wherein said data unit sender sets a time stamp indicative of the time of sending in each sent data unit, where said data unit receiver is arranged to set the time stamp of the last correctly received data unit in any acceptable or duplicate acknowledgement being sent, wherein said data unit sender performs round trip time measurements based on said time stamps set in received acceptable and duplicate acknowledgments.

17. The method of claim 1, wherein said procedure for detecting a data unit loss indication comprises monitoring a predetermined time-out period after sending a given data unit, and judging a data unit loss indication to be present if said predetermined time-out period passes without having received an acceptable acknowledgment message associated with said given data unit.

18. The method of claim 17, further comprising a procedure for increasing said time-out period in response to distinguishing that said acceptable acknowledgment message carrying the sequence position identifier indicative of said data unit indicated as potentially having been lost relates to said original transmission.

19. The method of claim 1, wherein said procedure for detecting a data unit loss indication comprises counting a number of duplicate acknowledgement messages, comparing said counted number with a threshold value and judging a data unit loss indication to be present if said counted number reaches said threshold value.

20. The method of claim 19, furthermore comprising a procedure for adapting said threshold value by monitoring the outcome of said distinguishing step for different data unit loss indication detection events.

21. (canceled)

22. A data unit sender arranged to operate in accordance with a communication protocol according to which a sending peer sends data units in a sequence, each data unit carrying a sequence position identifier, a receiving peer acknowledges the correct receipt of data units with acknowledgement messages, where each acknowledgement message carries a sequence position identifier indicative of the last data unit that was correctly received in the order of said sequence, the data unit sender comprising
a flow controller for controlling the flow of data units sent by said data unit sender in dependence on said acknowledgement messages and for utilizing an output limiting parameter for placing a limit on the data unit sender's current data send rate, said flow controller being arranged to recognize duplicate acknowledgement messages that carry a sequence position identifier that was already carried in a previously received acknowledgment message,
an adaptor for adapting said output limiting parameter for increasing said limit in dependence on acceptable acknowledgment messages, an acceptable acknowledgment message being an acknowledgment message that is associated with a data unit that was not previously acknowledged,
a detector for detecting a data unit loss indication,
a retransmitter for performing a retransmission of a data unit that said data unit loss indication indicates as potentially having been lost, in response to the detection of a data unit loss indication,
a monitor for waiting for an acceptable acknowledgment message carrying the sequence position identifier indicative of said data unit indicated as potentially having been lost, subsequent to said retransmission, and
a distinguisher for distinguishing whether said acceptable acknowledgment message relates to an original transmission of said data unit indicated as potentially having been lost, and
a congestion responder for performing a congestion response step for adapting said output limiting parameter for alleviating congestion, said congestion responder being triggered in response to said distinguisher distinguishing that said acceptable acknowledgment message does not relate to said original transmission, but not being triggered by said detector detecting a data unit loss indication,
where said adaptor is arranged for adapting said output limiting parameter based on one or more duplicate acknowledgment messages received since receiving the last acceptable acknowledgment message that precedes the acceptable acknowledgment message carrying the sequence position identifier indicative of said data unit indicated as potentially having been lost, in response to said distinguisher distinguishing that said acceptable acknowledgment message relates to said original transmission.

23-28. (canceled)

29. A communication system comprising:
a data unit sender arranged to operate as a sending peer of a first communication protocol according to which a sending peer sends data units in a sequence, each data unit carrying a sequence position identifier, a receiving peer acknowledges the correct receipt of data units with acknowledgement messages, where each acknowledgement message carries a sequence position identifier indicative of the last data unit that was correctly received in the order of said sequence,
said communication protocol belonging to a first layer,
said data unit sender comprising
a flow controller for controlling the flow of data units sent by said data unit sender in dependence on said acknowledgement messages, and for utilizing an output limiting parameter for placing a limit on the data unit sender's current data send rate,
a detector for detecting a data unit loss indication,
a retransmitter for performing a retransmission of a data unit that said data unit loss indication indicates as potentially having been lost, in response to the detection of a data unit loss indication,
a monitor for waiting for an acceptable acknowledgment message carrying the sequence position identifier indicative of said data unit indicated as potentially having been lost, subsequent to said retransmission, and
a distinguisher for distinguishing whether said acceptable acknowledgment message relates to an original transmission of said data unit indicated as potentially having been lost, and
a congestion responder for performing a congestion response step for adapting said output limiting parameter for alleviating congestion, said congestion responder being triggered in response to said distinguisher distinguishing that said acceptable acknowledgment message does not relate to said original transmission, but not being triggered by said detector detecting a data unit loss indication,
and said system further comprising
a further data unit sender arranged to operate as a sending peer of a second communication protocol that belongs to a second layer lower than said first layer, said second layer being a link layer, said further data unit sender being arranged to receive in the order of said sequence data units of a third communication protocol that belongs to a third layer over said second layer, comprising an embedding controller for embedding said data units of said third communication protocol in data units of said second communication protocol, and a send controller for sending said data units of said second communication protocol to a receiving peer of said second communication protocol,
a data unit receiver arranged to operate as said receiving peer of said second communication protocol, comprising a reconstruction controller for controlling the reconstruction of data units of said third communication protocol, and a release controller for releasing data units of said third communication protocol upwards, said release controller being arranged to be allowed to release said data units of said third communication protocol out of order of said sequence.

30. The system of claim 29, wherein said first layer and said third layer are identical.

31. The system of claim 29, wherein said first layer is a transport layer.

32. A method of controlling a communication that comprises a first data unit sender, a second data unit sender and a data unit receiver, said first data unit sender being arranged to operate as a sending peer of a first communication protocol according to which
the sending peer sending data units in a sequence, each data unit carrying a sequence position identifier,
a receiving peer acknowledging the correct receipt of data units with acknowledgement messages, where each acknowledgement message carries a sequence position identifier indicative of the last data unit that was correctly received in the order of said sequence, said communication protocol belonging to a first layer,
said second data unit sender operating as a sending peer of a second communication protocol that belongs to a second layer lower than said first layer, said second layer being a link layer, said further data unit sender being arranged to receive in the order of said sequence data units of a third communication protocol that belongs to a third layer over said second layer, and
said data unit receiver operating as a receiving peer of said second communication protocol,
controlling the flow of data units sent by said data unit sender in dependence on said acknowledgement messages, utilizing an output limiting parameter for placing a limit on the data unit sender's current data send rate,
detecting a data unit loss indication,
in response to the detection of a data unit loss indication, performing a retransmission of a data unit that said data unit loss indication indicates as potentially having been lost, but not performing a congestion response step for adapting said output limiting parameter for alleviating congestion,
subsequent to said retransmission waiting for an acceptable acknowledgment message carrying the sequence position identifier indicative of said data unit indicated as potentially having been lost,
distinguishing whether said acceptable acknowledgment message relates to an original transmission of said data unit indicated as potentially having been lost, and
in response to distinguishing that said acceptable acknowledgment message does not relate to said original transmission, performing said congestion response step,
embedding said data units of said third communication protocol in data units of said second communication protocol, and sending said data units of said second communication protocol to said data unit receiver, and
reconstructing said data units of said third communication protocol from said data units of said second communication protocol, and releasing data units of said third communication protocol upwards, where a releasing out of order of said sequence is allowed.

33. The method of claim 32, wherein said first layer and said third layer are identical.

34. The method of claim 32, wherein said first layer is a transport layer.
